(19) United States
(12) Patent Application Publication
(10) Pub. No.: US 2013/0342322 A1
(43) Pub. Date: Dec. 26, 2013

(54) RFID SYSTEM WITH ENCLOSURE AND INTERFERENCE PATTERN

(71) Applicants: Mark P. Hinman, Holley, NY (US); Edward Zogg, Ontario, NY (US)

(72) Inventors: Mark P. Hinman, Holley, NY (US); Edward Zogg, Ontario, NY (US)

(21) Appl. No.: 13/532,859

(22) Filed: Jun. 26, 2012

(51) Int. Cl. G06K 7/01

(52) U.S. Cl. CPC G06K 7/01
USPC 340/10.1

(57) ABSTRACT

An RFID system includes an RFID reader with a tag antenna located at a reader location. An RFID tag includes a controller and an antenna. An RF-blocking enclosure spaced apart from the RFID reader includes a port having first and second spaced-apart apertures. The enclosure is positioned with respect to the reader location to define a tag-antenna location at which an interference pattern of a downlink signal from the reader passing through the port provides a selected downlink power at the tag-antenna location, and an interference pattern of an uplink signal from the tag passing through the port provides a selected uplink power at the reader location. The tag antenna is located in the enclosure at the tag-antenna location.

### CROSS-REFERENCE TO RELATED APPLICATIONS

This application is co-filed with and has related subject matter to U.S. patent application Ser. No. ______ (attorney docket no. K000867), filed herewith, titled “RFID SYSTEM WITH MULTIPLE TAG TRANSMIT FREQUENCIES;” U.S. patent application Ser. No. ______ (attorney docket no. K000902), filed herewith, titled “RFID READING SYSTEM USING RF GRATING;” U.S. patent application Ser. No. ______ (attorney docket no. K000911), filed herewith, titled “RFID SYSTEM WITH BARRIERS AND KEY ANTENNAS;” U.S. patent application Ser. No. ______ (attorney docket no. K000966), filed herewith, titled “RFID SYSTEM WITH MULTIPLE READER TRANSMIT FREQUENCIES;” U.S. patent application Ser. No. ______ (attorney docket no. K000863), filed herewith, titled “READING RFID TAG USING ANTENNA WITHIN ENCLOSURE;” and U.S. patent application Ser. No. ______ (attorney docket no. K000965), filed herewith, titled “RFID SYSTEM WITH CONFIGURABLE RF PORT;” all of which are incorporated herein by reference.

### FIELD OF THE INVENTION

This invention pertains to the field of radio-frequency communication between radio-frequency identification (RFID) tags and RFID readers, and more securing such communication.

### BACKGROUND OF THE INVENTION

Various electronic equipment or devices can communicate using wireless links. A popular technology for communication with low-power portable devices is radio frequency identification (RFID). Standardized RFID technology provides communication between an interrogator (or “reader”) and a “tag” (or “transponder”), a portable device that transmits an information code or other information to the reader. Tags are generally much lower-cost than readers. RFID standards exist for different frequency bands, e.g., 125 kHz (LF, inductive or magnetic-field coupling in the near field), 13.56 MHz (HF, inductive coupling), 433 MHz, 860-960 MHz (UHF, e.g., 915 MHz, RF coupling beyond the near field), 2.4 GHz, or 5.8 GHz. Tags can use inductive, capacitive, or RF coupling (e.g., backscatter, discussed below) to communicate with readers. Although the term “reader” is commonly used to describe interrogators, “readers” (i.e., interrogators) can also write data to tags and issue commands to tags. For example, a reader can issue a “kill command” to cause a tag to render itself permanently inoperative.

Radio frequency identification systems are typically categorized as either “active” or “passive.” In an active RFID system, tags are powered by an internal battery, and data written into active tags can be rewritten and modified. In a passive RFID system, tags operate without an internal power source, instead being powered by received RF energy from the reader. “Semi-active” or “semi-passive” tags use batteries for internal power, but use power from the reader to transmit data. Passive tags are typically programmed with a unique set of data that cannot be modified. A typical passive RFID system includes a reader and a plurality of passive tags. The tags respond with stored information to coded RF signals that are typically sent from the reader. Further details of RFID systems are given in commonly-assigned U.S. Pat. No. 7,969,286 to Adelbert, and in U.S. Pat. No. 6,725,014 to Voegele, both of which are incorporated herein by reference.

In a commercial or industrial setting, tags can be used to identify containers of products used in various processes. A container with a tag affixed thereto is referred to herein as a “tagged container.” Tags on containers can carry information about the type of products in those containers and the source of those products. For example, as described in the GS1 EPC Tag Data Standard ver. 1.6, ratified Sep. 9, 2011, incorporated herein by reference, a tag can carry a “Serialized Global Trade Item Number” (SGTIN). Each SGTIN uniquely identifies a particular instance of a trade item, such as a specific manufactured item. For example, a manufacturer of cast-iron skillets can have, as a “product” (in GS1 terms) a 10″ skillet. Each 10″ skillet manufactured has the same UPC code, called a “Global Trade Item Number” (GTIN). Each 10″ skillet the manufacturer produces is an “instance” of the product, in GS1 terms, and has a unique Serialized GTIN (SGTIN). The SGTIN identifies the company that makes the product and the product itself (together, the GTIN), and the serial number of the instance. Each box in which a 10″ skillet is packed can have affixed thereto an RFID tag bearing the SGTIN of the particular skillet packed in that box. SGTINs and related identifiers, carried on RFID tags, can permit verifying that the correct products are used at various points in a process.

However, RFID tags in general, and specifically passive tags, often do not have enough processing power or memory to perform cryptographic authentication or authorization functions, such as secure hashing with time-varying salt. Consequently, every read of a tag returns the same data. As a result, RFID systems can be vulnerable to attacks in which a rogue (non-authorized) reader placed near a tag reads and stores that tag's data. This process is called “skimming,” and such rogue readers are referred to as “skimmers.” The skimmer can later replay the stored data (a “replay attack”) to pretend to be the skimmed tag (“spoofing”). This can result in incorrect products being used in industrial or commercial processes, or mishandled inventory in a retail environment, possibly resulting in lost productivity or wasted product. Skimmers can actively interrogate RFID tags, or passively wait and record data sent by tags being interrogated by authorized readers. In other cases, skimmers can passively record the data transfers by which an authorized reader opens a communications session with an RFID tag. The skimmer can then use this information to open a communications session with the RFID tag and make unauthorized changes to data stored on the tag.

Various schemes have been proposed to reduce vulnerability of RFID systems to skimmers. U.S. Patent Publication No. 2009/0174556 by Home et al. describes an RFID blocker that disrupts an RFID reader's signal to a tag when the blocker is physically near the tag. However, the blocker will disrupt all accesses, not just unauthorized access. In another scheme, U.S. Patent Publication No. 2009/0021343 by Sinha describes jamming or spoofing skimmers, either using authorized electronics or intrusion-prevention tags, in response to intrusions or policy violations. U.S. Pat. No. 7,086,587 to Myllymaki describes RFID readers that can detect unauthorized tags, and tags that can detect unauthorized readers. However, none of these schemes reduces the probability of passive monitoring by a skimmer during an authorized read of the tag. Moreover, tags affixed to objects are often used in factory or retail contexts in which a large number of tagged instances or packages (e.g., as described in U.S. Patent Publication No. 2009/0302972) carry RFID tags. This can result in contention between tags for the bandwidth, reducing the number of tags that can be read in a certain amount of time. For example, U.S. Patent Publication No. 2010/0265302 describes RFID tags on liquid ink containers. However, this reference does not recognize difficulties that can be encountered in reading RFID tags attached to RF-attenuating containers of liquid. Moreover, containers can come in various sizes and shapes, which can require adjusting antenna directions and gains to read at a desired rate of read success. Various prior-art schemes use readers with directional antennas to reduce the area of operation in which a skimmer can detect that a read is in progress.

U.S. Patent Publication No. 2010/0102969 describes a “Faraday shield” that reduces reading of unwanted RFID objects. This shield affects the radiation pattern of the antennas to reduce their power in the direction of the unwanted objects, but does not control access to tags in the direction of wanted objects. Consequently, an unwanted rogue tag, which could be active instead of passive, and thus much higher-powered than a standard tag, could still be accessed by the reader. Moreover, the shield might increase gain in the wanted direction, making it easier for an attacker to place a rogue tag within range of the reader.

U.S. Patent Publication No. 2009/0174556 by Horne et al. describes an RFID blocker that disrupts an RFID reader's signal to a tag when the blocker is physically near the tag. However, the blocker will disrupt all accesses, not just unauthorized access. Moreover, this scheme requires the blocker and the tag be moved apart from each other to access the tag.

There is a continuing need, therefore, for a way of controlling access to RFID tags located in fixed positions, e.g., attached to containers.

U.S. Pat. No. 8,025,228 describes distribution of products in a restricted access unit near the customer. Products are equipped with RF tags. A plurality of RF tagged products is placed within a cabinet that has a door or opening that can detect access to the cabinet. One or more antennas are positioned within the door. Each antenna may have a transmission line of sight and be configured to emit a signal at predefined frequencies. Each antenna generates an electromagnetic field within the micro-warehouse. In one embodiment, the products are positioned in one or more bins, compartments, or similar devices located within the micro-warehouse such that at least two of the plurality of products are spaced a distance from each other to reduce energy sharing. The electromagnetic field is moved or altered within the micro-warehouse through the use of reflectors, devices that move the antennas, or other mechanisms. However, this scheme is not applicable to environments such as retail stockrooms in which the tagged items are not confined in a cabinet.

There is, therefore, a continuing need for ways of reading RFID tags securely, in tag-rich environments.

### SUMMARY OF THE INVENTION

According to an aspect of the present invention, there is provided an RFID system, comprising:

a) an RFID reader having a reader antenna located at a reader location, the RFID reader adapted to transmit a downlink signal at a selected RF downlink frequency and to receive an uplink signal at a selected RF uplink frequency;

b) an RFID tag including a controller and a tag antenna coupled to the controller, and adapted to transmit the uplink signal using the tag antenna; and

c) an RF-blocking enclosure spaced apart from the RFID reader;

wherein

d) the enclosure includes a port having first and second spaced-apart apertures, each aperture having a respective selected shortest dimension;

e) the enclosure is positioned with respect to the reader location to define a tag-antenna location at which an interference pattern of the downlink signal passing through the port provides a selected downlink power at the tag-antenna location, and an interference pattern of the uplink signal passing through the port provides a selected uplink power at the reader location; and

f) the tag antenna is located in the enclosure at the tag-antenna location.

An advantage of this invention is that it restricts the locations from which a reader can communicate with a tag. This reduces the range of positions from which a skimmer can monitor tag transmissions. In various embodiments, the enclosures surrounding adjacent tags are oriented to direct signals to different readers, reducing spatial contention. Various embodiments use standard readers and tags and do not require custom security electronics or protocols.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a block diagram of an RFID system according to various embodiments;

FIG. 2 is a block diagram of a passive RFID tag according to various embodiments;

FIG. 3 is a high-level diagram showing the components of a processing system useful with various embodiments; and

FIGS. 4-6 show RFID systems according to various embodiments.

The attached drawings are for purposes of illustration and are not necessarily to scale.

### DETAILED DESCRIPTION OF THE INVENTION

As used herein, the term “uplink” refers to communications from an RFID tag to a reader, and “downlink” to communications from a reader to a tag. These terms are used regardless of which side initiates the communication.

In the following description, some embodiments will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, methods described herein. Other aspects of such algorithms and systems, and hardware or software for producing and otherwise processing the image signals involved therewith, not specifically shown or described herein, are selected from such systems, algorithms, components, and elements known in the art. Given the system as described herein, software not specifically shown, suggested, or described herein that is useful for implementation of various embodiments is conventional and within the ordinary skill in such arts.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice methods according to various embodiments.

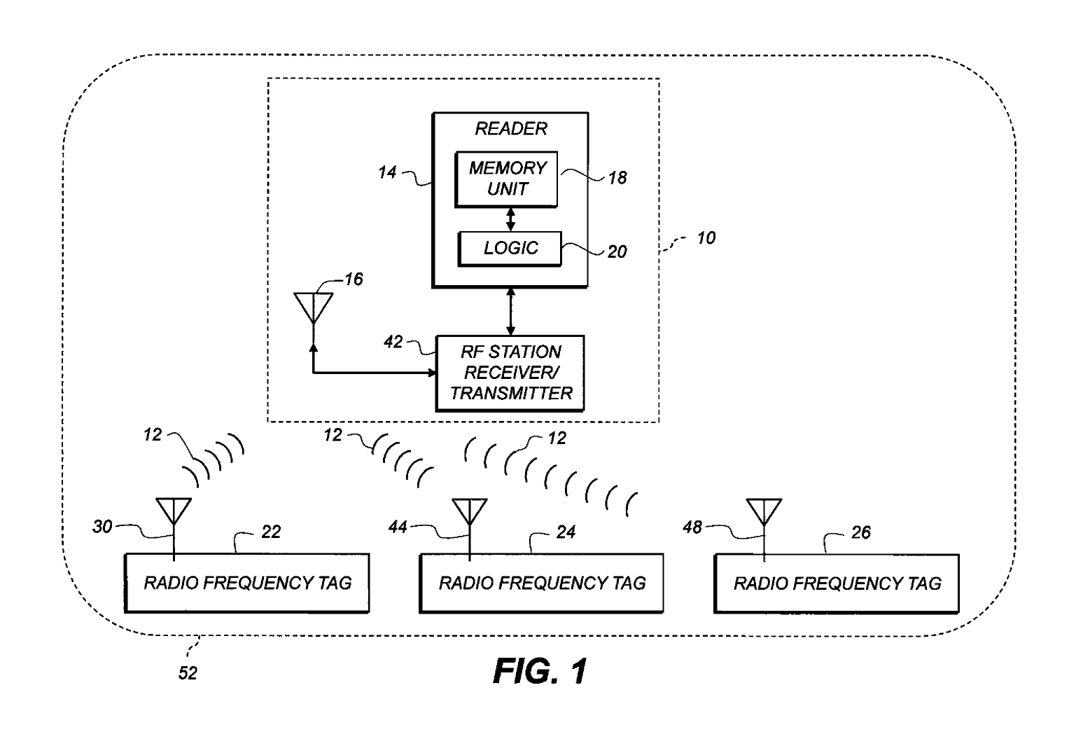

FIG. 1 is a block diagram of an RFID system according to various embodiments. Base station 10 communicates with three RF tags 22, 24, 26, which can be active or passive in any combination, via a wireless network across an air interface 12. FIG. 1 shows three tags, but any number can be used. Base station 10 includes reader 14, reader's antenna 16 and RF station 42. RF station 42 includes an RF transmitter and an RF receiver (not shown) to transmit and receive RF signals via reader's antenna 16 to or from RF tags 22, 24, 26. Tags 22, 24, 26 transmit and receive via respective antennas 30, 44, 48.

Reader 14 includes memory unit 18 and logic unit 20. Memory unit 18 can store application data and identification information (e.g., tag identification numbers) or SGTINs of RF tags in range 52 (RF signal range) of reader 14. Logic unit 20 can be a microprocessor, FPGA, PAL, PLA, or PLD. Logic unit 20 can control which commands that are sent from reader 14 to the tags in range 52, control sending and receiving of RF signals via RF station 42 and reader's antenna 16, or determine if a contention has occurred.

Reader 14 can continuously or selectively produce an RF signal when active. The RF signal power transmitted and the geometry of reader's antenna 16 define the shape, size, and orientation of range 52. Reader 14 can use more than one antenna to extend or shape range 52. Reader 14 and tags 22, 24, 26 can communicate using, e.g., the EPC Class-1 Generation-2 UHF RFID Protocol for Communications at 860 MHz-960 MHz, Version 1.2.0, Oct. 23, 2008, incorporated herein by reference.

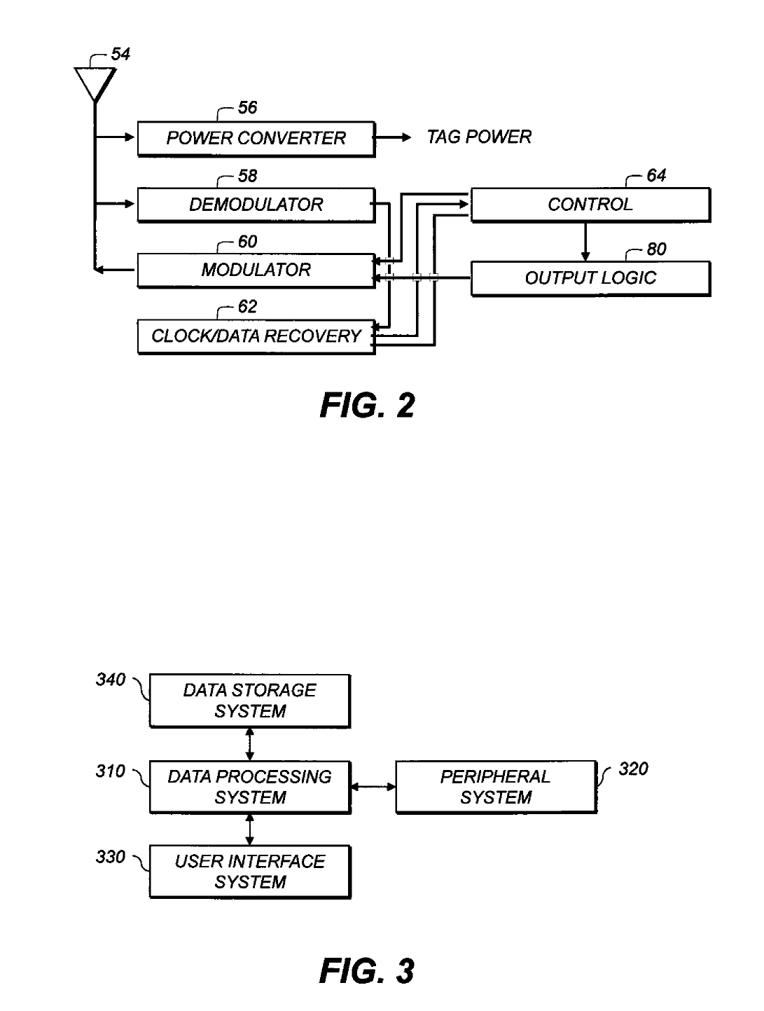

FIG. 2 is a block diagram of a passive RFID tag (e.g., tags 22, 24, 26 according to an embodiment of the system shown in FIG. 1) according to various embodiments. The tag can be a low-power integrated circuit, and can employ a “coil-on-chip” antenna for receiving power and data. The RFID tag includes antenna 54 (or multiple antennas), power converter 56, demodulator 58, modulator 60, clock/data recovery circuit 62, control unit 64, and output logic 80. Antenna 54 can be an omnidirectional antenna impedance-matched to the transmission frequency of reader 14 (FIG. 1). The RFID tag can include a support, for example, a piece of polyimide (e.g., KAPTON) with pressure-sensitive adhesive thereon for affixing to packages. The tag can also include a memory (often RAM in active tags or ROM in passive tags) to record digital data, e.g., an SGTIN.

Reader 14 (FIG. 1) charges the tag by transmitting a charging signal, e.g., a 915 MHz sine wave. When the tag receives the charging signal, power converter 56 stores at least some of the energy being received by antenna 54 in a capacitor, or otherwise stores energy to power the tag during operation.

After charging, reader 14 transmits an instruction signal by modulating onto the carrier signal data for the instruction signal, e.g., to command the tag to reply with a stored SGTIN. Demodulator 58 receives the modulated carrier bearing those instruction signals. Control unit 64 receives instructions from demodulator 58 via clock/data recovery circuit 62, which can derive a clock signal from the received carrier. Control unit 64 determines data to be transmitted to reader 14 and provides it to output logic 80. For example, control unit 64 can retrieve information from a laser-programmable or fusible-link register on the tag. Output logic 80 shifts out the data to be transmitted via modulator 60 to antenna 54. The tag can also include a cryptographic module (not shown). The cryptographic module can calculate secure hashes (e.g., SHA-1) of data or encrypt or decrypt data using public- or private-key encryption. The cryptographic module can also perform the tag side of a Diffie-Hellman or other key exchange.

Signals with various functions can be transmitted; some examples are given in this paragraph. Read signals cause the tag to respond with stored data, e.g., an SGTIN. Command signals cause the tag to perform a specified function (e.g., kill). Authorization signals carry information used to establish that the reader and tag are permitted to communicate with each other.

Passive tags typically transmit data by backscatter modulation to send data to the reader. This is similar to a radar system. Reader 14 continuously produces the RF carrier sine wave. When a tag enters the reader's RF range 52 (FIG. 1; also referred to as a “field of view”) and receives, through its antenna from the carrier signal, sufficient energy to operate, output logic 80 receives data, as discussed above, which is to be backscattered.

Modulator 60 then changes the load impedance seen by the tag's antenna in a time sequence corresponding to the data from output logic 80. Impedance mismatches between the tag antenna and its load (the tag circuitry) cause reflections, which result in momentary fluctuations in the amplitude or phase of the carrier wave bouncing back to reader 14. Reader 14 senses for occurrences and timing of these fluctuations and decodes them to receive the data clocked out by the tag. In various embodiments, modulator 60 includes an output transistor (not shown) that short-circuits the antenna in the time sequence (e.g., short-circuited for a 1 bit, not short-circuited for a 0 bit), or opens or closes the circuit from the antenna to the on-tag load in the time sequence. In another embodiment, modulator 60 connects and disconnects a load capacitor across the antenna in the time sequence. Further details of passive tags and backscatter modulation are provided in U.S. Pat. No. 7,965,189 to Shanks et al. and in “Remotely Powered Addressable UHF RFID Integrated System” by Curty et al., IEEE Journal of Solid-State Circuits, vol. 40, no. 11, November 2005, both of which are incorporated herein by reference. As used herein, both backscatter modulation and active transmissions are considered to be transmissions from the RFID tag. In active transmissions, the RFID tag produces and modulates a transmission carrier signal at the same wavelength or at a different wavelength from the read signals from the reader.

FIG. 3 is a high-level diagram showing the components of a processing system useful with various embodiments. The system includes a data processing system 310, a peripheral system 320, a user interface system 330, and a data storage system 340. Peripheral system 320, user interface system 330 and data storage system 340 are communicatively connected to data processing system 310.

Data processing system 310 includes one or more data processing devices that implement the processes of various embodiments, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

Data storage system 340 includes one or more processor-accessible memories configured to store information, including the information needed to execute the processes of various embodiments. Data storage system 340 can be a distributed processor-accessible memory system including multiple processor-accessible memories communicatively connected to data processing system 310 via a plurality of computers or devices. Data storage system 340 can also include one or more processor-accessible memories located within a single data processor or device. A “processor-accessible memory” is any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” refers to any type of connection, wired or wireless, between devices, data processors, or programs in which data can be communicated. This phrase includes connections between devices or programs within a single data processor, between devices or programs located in different data processors, and between devices not located in data processors at all. Therefore, peripheral system 320, user interface system 330, and data storage system 340 can be included or stored completely or partially within data processing system 310.

Peripheral system 320 can include one or more devices configured to provide digital content records to data processing system 310, e.g., digital still cameras, digital video cameras, cellular phones, or other data processors. Data processing system 310, upon receipt of digital content records from a device in peripheral system 320, can store such digital content records in data storage system 340. Peripheral system 320 can also include a printer interface for causing a printer to produce output corresponding to digital content records stored in data storage system 340 or produced by data processing system 310.

User interface system 330 can include a mouse, a keyboard, another computer, or any device or combination of devices from which data is input to data processing system 310. Peripheral system 320 can be included as part of user interface system 330. User interface system 330 also can include a display device, a processor-accessible memory, or any device or combination of devices to which data is output by data processing system 310. If user interface system 330 includes a processor-accessible memory, such memory can be part of data storage system 340 even though user interface system 330 and data storage system 340 are shown separately in FIG. 1.

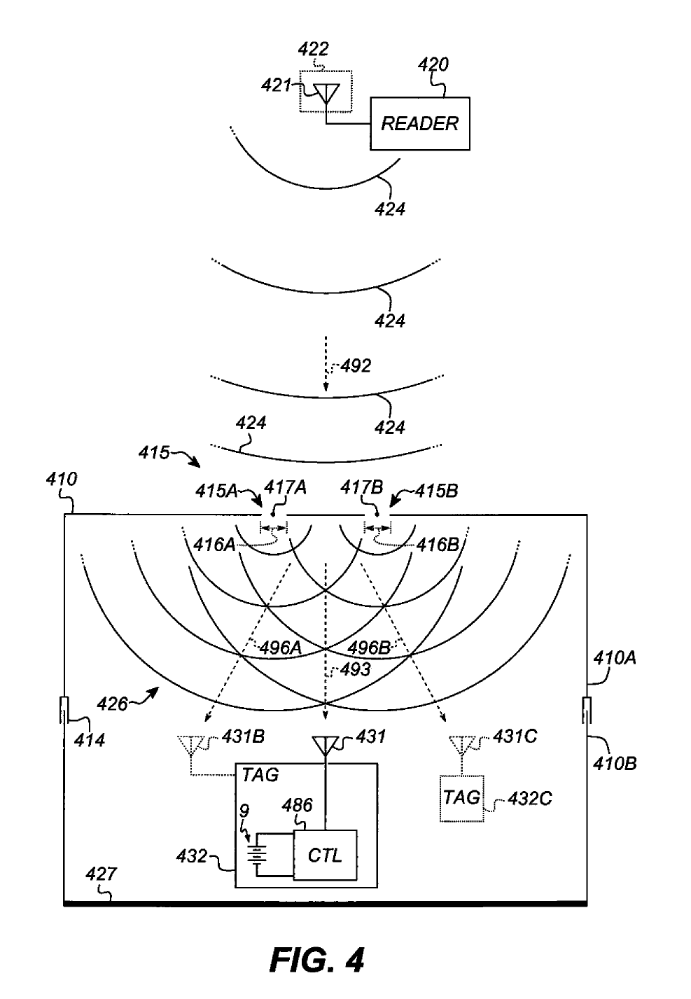

FIG. 4 shows an RFID system. RFID reader 420 has reader antenna 421 located at reader-antenna location 422. RFID reader 420 is adapted to transmit a downlink signal at a selected RF downlink frequency or band (range) of frequencies and to receive an uplink signal at a selected RF uplink frequency (or band/range). The uplink and downlink signals can use the same or different frequencies or frequency bands. Examples of circular wavefronts 424 are shown propagating from antenna 421. As each wavefront 424 approaches enclosure 410, its radius increases and it more closely approximates a plane wave.

RF-blocking enclosure 410 is spaced apart from RFID reader 420. Enclosure 410 can include a single piece or multiple pieces brought together. Enclosure 410 can include a door (not shown) that can open to permit putting tags in and taking them out of enclosure 410, or enclosure 410 can include multiple parts (e.g., a body and a lid, not shown) that can be separated to access tag 432, then put back together to reform enclosure 410. In an example, enclosure 410 includes portions 410A, 410B that interlock at joint 414 to form enclosure 410.

RF-blocking enclosure 410 substantially blocks RF energy at selected RFID wavelength(s) except through port 415, as is discussed below. Port 415 can include openings or RF-transparent windows. “Blocking” means that enclosure 410 is designed (e.g., in shape or material) to attenuate incident RF energy, e.g., from a skimmer, until the energy that passes into the enclosure is below the receive sensitivity of the RFID tag, or the response from the RFID tag is below the receive sensitivity of a reader or skimmer outside the enclosure. It is not required that the enclosure be entirely RF-opaque, whether only at a frequency of interest or over a frequency band.

RFID tag 432 is located in enclosure 410. Tag 432 can be active, semi-active, or passive. Controller 486, which can include a CPU, microcontroller, PLD, PLA, PAL, FPGA, ASIC, or other logic or software-execution device, controls the operation of tag 432. In various embodiments, tag 432 includes battery 9.

Tag 432 includes tag antenna 431 coupled to controller 486 and located in enclosure 410. The tag can be multiple pieces or one assembly. The RFID IC holding controller 486 can be inside or outside enclosure 410. Tag 432 is adapted to transmit an uplink signal using tag antenna 431.

Port 415 in enclosure 410 includes first and second spaced-apart apertures 415A, 415B. Each aperture 415A, 415B can be a hole, a slit, or another shape, and apertures 415A, 415B can have the same shapes or different shapes. Each aperture 415A, 415B has a respective selected shortest dimension 416A, 416B between any two points on the periphery of aperture 415A, 415B. These dimensions affect the propagation characteristics of radio waves through port 415.

Specifically, dimensions 416A, 416B are selected so that the transmissions of the uplink and downlink RF signals through port 415 occur substantially by diffraction rather than transmission. The uplink and downlink wavelengths are selected to satisfy the same requirement. For example, in the far-field (Fraunhofer) approximation in which the distance (D) the downlink signal at the downlink wavelength travels from port 415 to antenna 431 is significantly greater than dimension 416A (a), the angular half-width (θ) of the diffraction pattern inside enclosure 410 for downlink wavelength λ is:

θ≈sin⁻¹(λ/a) (Eq. 1)

As a result, the larger the downlink wavelength is with respect to dimension 416A or 416B, the more the downlink signal will spread inside enclosure 410. For example, with λ/a=1, θ≈90°. Consequently, dimensions 416A, 416B can be selected for a selected downlink wavelength so that the interference pattern of the diffracted signals inside enclosure 410 carries the downlink signal to the location of tag antenna 431. For incident plane waves, the orientation of the interference pattern inside enclosure 410 depends on the direction of incidence of the waves. This restricts the set of locations from which a skimmer can reach tag 432, reducing the probability that skimmers will be able to access tag 432 without detection.

For example, in a factory environment, antenna 421 is located at the appropriate location (reader-antenna location 422) to communicate with tag 432. The location of antenna 421 and reader 420 can be selected so that if skimmer hardware is installed in place of the normal hardware, that change will be visible to factory personnel.

Specifically, enclosure 410 is positioned with respect to location 422 of reader antenna 421 to define a tag-antenna location (not labeled; where antenna 431 is). Interference pattern 426 of the diffracted downlink signals passing through apertures 415A, 415B of port 415 provides a selected RF downlink power at the tag-antenna location. Intersections between the arcs shown for interference pattern 426 represent areas of constructive interference. Pattern 426 therefore includes peaks extending along directions 496A, 493, 496B, and nulls extending along directions between those. Tag antenna 431 is located in enclosure 410 at the tag-antenna location. Moreover, the spatial relationship between the tag antenna location and port 415 is selected so that an interference pattern of the uplink signal (not shown) from tag antenna 431 passing through port 415 provides a selected RF uplink power at reader-antenna location 422.

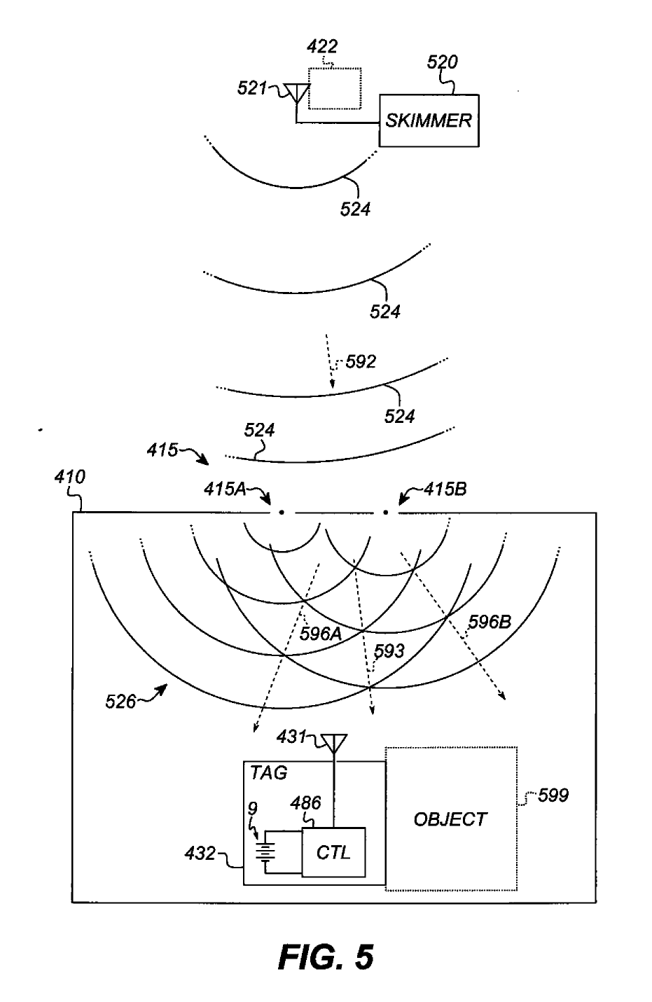

RF power can be measured with respect to the noise floor of the receiver in tag 432 or reader 420, as appropriate. The signal power can be selected so the signal-to-noise (S/N) ratio of the signal at the appropriate receiver exceeds the receiver's sensitivity threshold. In an example, a skimmer with an antenna not along direction 492 results in an interference pattern 426 with the center beam pointing in other than direction 493. As a result of the attenuation of the downlink signal power away from the peaks of interference pattern 426, the skimmer cannot provide enough power to communicate with tag 432 via antenna 431. An example of this is discussed below with reference to FIG. 5. In various embodiments, tag 432 is a passive tag and the RF downlink power is at least the power required to energize tag 432. As used herein, “providing a selected power” refers to providing at least the selected download power, unless explicitly indicated otherwise.

In various embodiments, each aperture 415A, 415B has a respective centroid 417A, 417B, and the centroids 417A, 417B are spaced apart by a centroid spacing. Port 415 includes a third aperture (not shown) with a respective centroid and a respective selected shortest dimension. The centroid of the third aperture is spaced apart from the centroids 417A, 417B of the two apertures 415A, 415B by respective centroid spacings. In various embodiments, any number greater than one of apertures 415A, 415B can be used in port 415. The number, shape, size, and spacing of apertures 415A, 415B in port 415 can be selected to control the reader- and tag-antenna locations, as discussed above. Direction 492 from reader-antenna location 422 to port 415, or a selected point thereon, or the center thereof, can be different than direction 493 from the port (or a point thereon) to the tag-antenna location by at least 15°.

In various embodiments, the enclosure is adapted to internally reflect at least some of the downlink signal, so that RF energy from the downlink signal passes within an antenna range of the tag-antenna location so that it can be received by tag antenna 431. The signal passes tag antenna 431 with at least a selected bounce frequency that is at least three times the downlink frequency. Tag 432 smooths the received pulses, either actively or passively by the innate filter characteristics of antenna 431 and the receiver circuitry in tag 432.

In various embodiments, interference pattern 426 includes a plurality of peaks and a plurality of nulls. The tag-antenna location is within one of the peaks (e.g., tag antenna 431 along the extension of direction 493). Tag 432 further includes second tag antenna 431B located within one of the peaks (here, along the extension of direction 496A). Antennas 431B, 431 can be located in the same peak or (as shown) different peaks. This permits tag 432 to receive more power from the downlink RF signal.

In various embodiments, enclosure 410 further includes RF-attenuating material 427 on at least one inside surface thereof. In various embodiments, RF-attenuating material 427 is disposed over substantially all the inside surfaces of enclosure 410 except for apertures 415A, 415B. This substantially reduces reflections, simplifying the determination of the downlink-signal interference pattern in enclosure 410. In various embodiments, the material and thickness of the material forming enclosure 410 are selected to provide a desired degree of RF-energy absorption or reflection at the downlink or uplink frequencies.

In various embodiments, second RFID tag 432C having second tag antenna 431C is located in enclosure 410. Interference pattern 426 further defines a second tag-antenna location (not labeled) in enclosure 410. Second tag antenna 431C is positioned at the second tag-antenna location.

In various embodiments, the enclosure includes two or more portions that are mechanically disconnected. At least one of the portions can be moved to position the enclosure. The portion can be moved by a motor, piston, or other actuator, directly or through a belt, gear train, rack and pinion, or any combination.

In various embodiments, the downlink RF signal includes a plurality of pulses separated in time. The pulses can include chirps, CW pulses, wavelets, or other signals having a limited time extent. Enclosure 410 is adapted to internally reflect at least some of the downlink signal, and is configured (e.g., shaped) so that a given RF wavefront in interference pattern 426 of the downlink signal passes within an antenna range of the tag-antenna location (i.e., can be received by the tag antenna) both before and after reflecting off the interior of enclosure 410. As a result, pulses of RF energy (before or after reflection) pass the tag with at least a selected bounce frequency. Reader 420 transmits the downlink signal with the pulses timed so that a bounce signal from a first of the plurality of pulses, i.e., a reflection of that pulse, reaches the tag-antenna location at substantially the same time as a second of the plurality of pulses before reflecting. The downlink pulses are timed so the reflected first pulse and the pre-reflection second pulse constructively interfere to increase the RF downlink power at tag antenna 431.

FIG. 5 shows an example of skimmer 520 with antenna 521 not in reader-antenna location 422. Circular wavefronts 524 propagate from antenna 521 along direction 592 towards port 415 and reach aperture 415A before aperture 415B. This changes the relative phase of circular wavefronts propagating from apertures 415A, 415B, effectively rotating interference pattern 526 compared to interference pattern 426 (FIG. 4). The peaks of interference pattern 526 are along directions 596A, 593, 596B. Tag antenna 431 is not along one of these directions 596A, 593, 596B, so the RF downlink power from skimmer 520 at tag antenna 431 is much lower than the power from a reader with an antenna in location 422, (shown in FIG. 4). Tag 432, controller 486, battery 9, enclosure 410, and port 415 are as shown in FIG. 4.

FIG. 5 also shows an example of RF-blocking, non-RFID-active object 599 within enclosure 410. Object 599 can block or reflect RF energy. The tag-antenna location is further defined by the shape and location of the object in the enclosure. In an example, object 599 absorbs RF energy, so the tag-antenna location is not on the opposite side of object 599 from port 415. In another example, object 599 reflects RF energy, so the tag-antenna location is a location at which RF signals from port 415 and reflecting off object 599 constructively interfere. In some embodiments, enclosure 410 is the retail or wholesale packaging for object 599, e.g., a cardboard box. In an example, object 599 is wrapped in foil and enclosure 410 has an RF-reflective inner surface. Object 599 is arranged in enclosure 410 to define a waveguide that carries RF energy from a peak of interference pattern 426 (FIG. 4) corresponding to a downlink signal from reader 420 (FIG. 4) in reader-antenna location 422 to tag antenna 431.

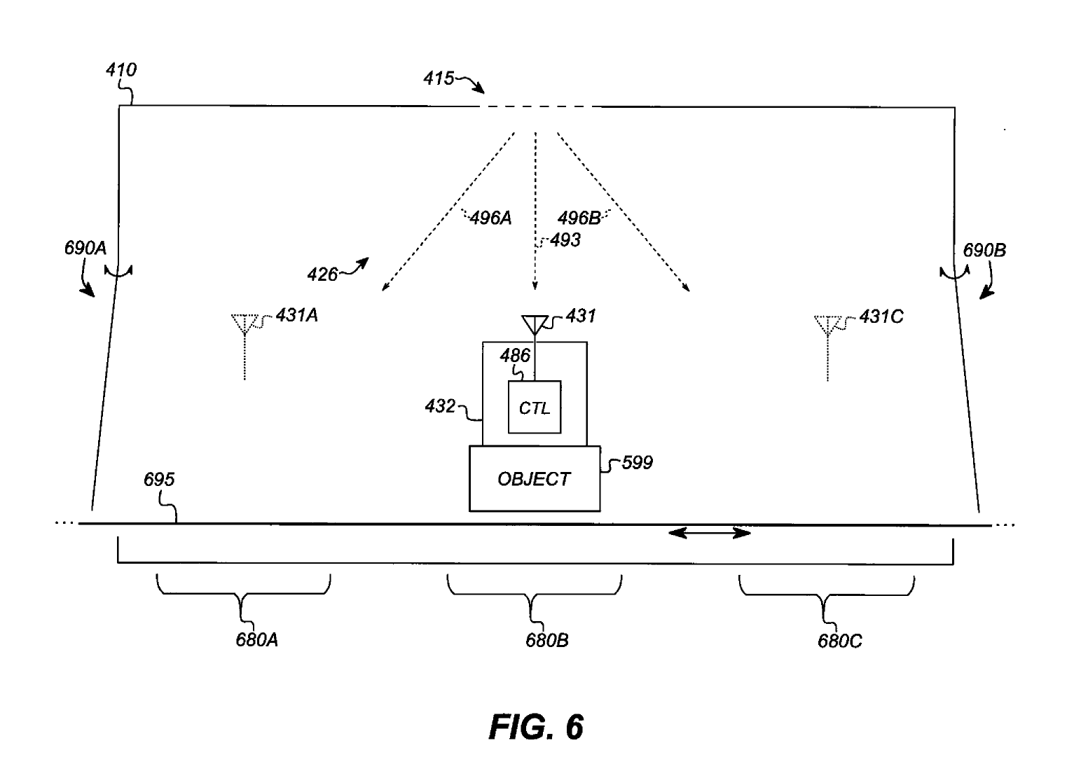

Referring to FIG. 6, in various embodiments, enclosure 410 includes two conveyor ports 690A, 690B through which non-RFID-active objects 599 are carried on conveyor 695. In this example, conveyor ports 690A, 690B are shown as selectively coverable by top-hinged doors or flaps. Other forms of RF sealing can also be used, e.g., louvers placed over conveyor ports 690A, 690B; a conventional gate that swings or slides open and closed and that is made from conductive or RF-absorbing material; a conductive or RF-absorbing drawbridge; an iris, aperture, or diaphragm; one or more flaps hinged at their respective connections with the enclosure; or a rotatable cover having a port corresponding to conveyor port 690A or 690B. Conveyor 695 can include a belt, rollers, arms, or other ways of carrying objects 599. A plurality of object locations 680A, 680B, 680C is defined in enclosure 410. Object locations 680A, 680B, 680C are positions objects 599 can be when an RFID read is attempted. The apertures (FIG. 4) in port 415 are positioned so that interference pattern 426 of the downlink signal passing through port 415 provides the selected RF downlink power to fewer than all of the object locations 680A, 680B, 680C.

In this example, object 599 with tag 432 affixed thereto is shown in location 680B. Controller 486 and tag antenna 431 are as shown in FIG. 4. Antennas 431A, 431C are shown where they would be for objects (not shown) in locations 680A, 680C, respectively. Tag antennas 431A, 431, 4310 on objects in locations 680A, 680B, 680C, respectively, are spaced more widely than the peaks of interference pattern 426 (extending along directions 496A, 493, 496B). Therefore, in this example, the selected downlink power is provided to the one of the object locations 680B corresponding to the tag-antenna location (not shown), and not to any other object location 680A, 680C.

Object locations 680A, 680B, 680C are determined by the spacing between objects 599 on conveyor 695 and the timing of RFID reads. A controller (not shown) can be used to coordinate RFID reads and conveyor motion to determine the object locations. The number and configuration of apertures in port 415 can be selected, using antenna-design techniques known in the art, to provide a desired pattern of peaks and nulls. MATLAB, ANSYS MAXWELL, or other field-solver software programs can be used to determine interference pattern 426 for a selected configuration of apertures.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

9 battery
10 base station
12 air interface
14 reader
16 reader's antenna
18 memory unit
20 logic unit
22, 24, 26 RFID tag
30, 44, 48 antenna
42 RF station
52 range
54 antenna
56 power converter
58 demodulator
60 modulator
62 clock/data recovery circuit
64 control unit
80 output logic
310 data-processing system
320 peripheral system
330 user-interface system
340 data-storage system
410 enclosure
410A, 410B portion
414 joint
415 port
415A, 415B aperture
416A, 416B shortest dimension
417A, 417B centroid
420 reader
421 reader antenna
422 reader-antenna location
424 wavefront
426 interference pattern
427 RF-attenuating material
431, 431A, 431B, 431C antenna
432, 432C RFID tag
486 controller
492 direction
493, 496A, 496B direction
520 skimmer
521 skimmer antenna
524 wavefront
526 interference pattern
592, 593, 596A, 596B direction
599 object
680A, 680B, 680C object location
690A, 690B conveyor port
695 conveyor

1. An RFID system, comprising:
a) an RFID reader having a reader antenna located at a reader location, the RFID reader adapted to transmit a downlink signal at a selected RF downlink frequency and to receive an uplink signal at a selected RF uplink frequency;
b) an RFID tag including a controller and a tag antenna coupled to the controller, and adapted to transmit the uplink signal using the tag antenna; and
c) an RF-blocking enclosure spaced apart from the RFID reader;
wherein
d) the enclosure includes a port having first and second spaced-apart apertures, each aperture having a respective selected shortest dimension;
e) the enclosure is positioned with respect to the reader location to define a tag-antenna location at which an interference pattern of the downlink signal passing through the port provides a selected downlink power at the tag-antenna location, and an interference pattern of the uplink signal passing through the port provides a selected uplink power at the reader location; and
f) the tag antenna is located in the enclosure at the tag-antenna location.

2. The system according to claim 1, wherein each aperture has a respective centroid and the centroids are spaced apart by a centroid spacing, and the port further includes a third aperture with a respective centroid and a respective selected shortest dimension, the centroid of the third aperture being spaced apart from the centroids of the first and the second spaced-apart apertures by respective centroid spacings.

3. The system according to claim 1, wherein a direction from the reader location to the port is different than a direction from the port to the tag-antenna location by at least 15°.

4. The system according to claim 1, wherein the enclosure is adapted to internally reflect at least some of the downlink signal, so that RF energy from the downlink signal passes within an antenna range of the tag-antenna location with at least a selected bounce frequency, and the selected bounce frequency is at least three times the downlink frequency.

5. The system according to claim 1, wherein the interference pattern includes a plurality of peaks and a plurality of nulls, the tag-antenna location is within one of the peaks, and the tag further includes a second tag antenna located within one of the peaks.

6. The system according to claim 1, wherein the enclosure further includes RF-attenuating material on at least one inside surface thereof.

7. The system according to claim 1, further including a second RFID tag having a second tag antenna, wherein the interference pattern further defines a second tag-antenna location in the enclosure and the second tag antenna is positioned at the second tag-antenna location.

8. The system according to claim 1, wherein the enclosure includes two portions that are mechanically disconnected, further including means for moving at least one of the portions to position the enclosure.

9. The system according to claim 1, further including an RF-blocking, non-RFID-active object within the enclosure so that the tag-antenna location is further defined by the shape and location of the object in the enclosure.

10. The system according to claim 1, wherein the enclosure is adapted to internally reflect at least some of the downlink signal, so that RF energy from the downlink signal passes within an antenna range of the tag-antenna location with at least a selected bounce frequency, and wherein the reader is adapted to transmit the downlink signal including a plurality of pulses separated in time so that a bounce signal from a first of the plurality of pulses reaches the tag-antenna location at substantially the same time as a second of the plurality of pulses.

11. The system according to claim 1, further including a conveyor for moving non-RFID-active objects, wherein the enclosure further includes two conveyor ports through which objects are carried on the conveyor so that a plurality of object locations in the enclosure are defined, and the apertures are positioned so that the interference pattern of the downlink signal passing through the port provides the selected downlink power to fewer than all of the object locations.

12. The system according to claim 11, wherein the selected downlink power is provided to the one of the object locations corresponding to the tag-antenna location, and not to any other object location.
